(19) United States
(12) Patent Application Publication
(10) Pub. No.: US 2011/0225037 A1
(43) Pub. Date: Sep. 15, 2011

(54) Advertising Exchange System Valuation of Information Services

(76) Inventors: Tunay Tunca, Palo Alto, CA (US); Joaquin Arturo Delgado Rodriguez, Santa Clara, CA (US)

(21) Appl. No.: 12/720,528

(22) Filed: Mar. 9, 2010

(51) Int. Cl. G06Q 30/00

(52) U.S. Cl. 705/14.46; 705/14.71

(57) ABSTRACT

Disclosed is a system to price usage of a user-action Probability estimation system provided by an advertising exchange system. A bid from each bidder in an auction for an advertising opportunity is presented in a computer. The bidders comprise a first group of bidders that utilize the Probability estimation system and a second group of bidders that do not utilize the Probability estimation system. The bids are processed by determining a first equilibrium bid for a first bidder as a member of the first group. The bids are further processed by determining a second equilibrium bid for the first bidder as a member of the second group. The system then utilizes the first equilibrium bid and the second equilibrium bid to determine a value of utilizing the Probability estimation system.

### BACKGROUND

1. Field

The information disclosed relates to bidding for an impression opportunity in an online advertising exchange system. More particularly, the information disclosed relates to an online advertising exchange system that may determine a value of using probability estimation of a user-action in bidding for an impression opportunity over not using such probability estimation in bidding for that same impression opportunity.

2. Background Information

The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Unlike print and television advertisement that primarily seeks to reach a target audience, Internet advertising seeks to reach target individuals. The individuals need not be in a particular geographic location and Internet advertisers may elicit responses and receive instant responses from individuals. As a result, Internet advertising is a much more cost effective channel in which to advertise.

Buying and selling ads online requires a variety of market players, including advertisers, publishers, agencies, networks, partners, and developers. To simplify the process of buying and selling ads online, some companies provide mutual organization systems that connect advertisers and publishers in a unified platform that serves as exchange facilities for advertisers, publishers, and other market players to buy and sell ads online. While some of these systems are efficient and effective, it is desirable to provide additional digital advertising solutions that continue to streamline the process of planning, buying, and/or optimizing display advertising.

### SUMMARY

A system prices usage of a probability estimation system that provides bidding information to users participating in an advertising exchange system auction. In order to calculate the value in using the probability estimation program, bidders are grouped into a first group of bidders that utilize the probability estimation program and a second group of bidders that do not utilize the probability estimation program. Under the assumption that all other bidders stay in the group they belong, the bids are processed by determining a first equilibrium bid for a first bidder by assuming the first bidder is in the first group. The bids are further processed by determining a second equilibrium bid for the first bidder by assuming that the first bidder is in the second group. The system then utilizes the first equilibrium bid and the second equilibrium bid to determine a value of utilizing the probability estimation program.

### BRIEF DESCRIPTION OF THE FIGURES

FIG. 1 illustrates one embodiment of an ad delivery system.

FIG. 2 illustrates another embodiment of an ad exchange system.

FIG. 3 illustrates another embodiment of an advertisement exchange system.

FIG. 4 is flow diagram illustrating a process 200 to value usage of a probability estimation program to bid for an impression opportunity in advertising exchange system 300.

FIG. 5 is line chart illustrating the effect of signal and noise variances on calculation of integration value for a second group k-bidder.

FIG. 6 is process 400 to price usage of a probability estimation program in bidding for an impression opportunity within advertising exchange system 300.

FIG. 7 is a block diagram that may serve as part of a price recommendation engine 500 through data analysis.

FIG. 8 is a bar chart that illustrates a histogram 800.

FIG. 9 is a bar chart that illustrates a histogram 900.

FIG. 10 is a bar chart that illustrates a histogram 1000.

FIG. 11 is a bar chart that illustrates a histogram 1100.

FIG. 12 is a bar chart that illustrates a histogram 1200.

FIG. 13 is a bar chart that illustrates a histogram 1300.

FIG. 14 is a bar chart that illustrates a histogram 1400.

FIG. 15 is a bar chart that illustrates a histogram 1500.

FIG. 16 is a bar chart that illustrates a histogram 1600.

FIG. 17 is a bar chart that illustrates a histogram 1700.

FIG. 18 is a bar chart that illustrates a histogram 1800.

FIG. 19 is a bar chart that illustrates a histogram 1900.

FIG. 20 is a diagrammatic representation of a network 2000.

### DETAILED DESCRIPTION

The embodiments of the advertising system are described using a number of terms. In order to aid in clarity, some definitions of the terms used to describe these embodiments follow. However, these terms define general concepts, and thus are not to be construed narrowly. A publisher is generally defined as a Web site that has inventory for the delivery of advertisements. As such, advertisements are displayed on the Web pages of the publisher's Web site. Users are generally defined as those individuals that access Web pages through use of a browser. However, the term user may also be used to describe entities that use the advertising exchange system, such as users that access an application on the advertising exchange system to use a probabilistic estimation system. Various participants of the advertising exchange system are referred to as “entities.” Thus, the term entity is generally used to describe any number of participants of the advertising exchange system. Those participants include advertisers, publishers, advertising networks and integrator networks.

An advertising network typically integrates entities, such as advertisers and publishers. An advertising network typically operates in conjunction with advertisers and publishers in order to deliver ads, from one or more advertisers, to Web pages of one or more publishers. For example, Yahoo! Inc, the assignee of the present invention, operates such an advertising network.

An integrator network entity generally defines a participant of the advertising exchange system that represents or integrates one or more entities on the advertising exchange system (e.g., advertisers, publishers, advertising networks, etc.). For example, an integrator network may represent advertisers on the advertising exchange system in order to deliver advertisements to publishers, advertising networks and other integrator networks. In some embodiments, the integrator networks are referred to as the “users” of the advertising exchange system. The integrated networks may comprise third party agents that operate on behalf of or are part of the integrator network. The term “third party agent” is used to generally describe an agent or customer that participates in transactions on the advertising exchange system. Similarly, the term “third party recipient” may be used to describe a user or participant of the advertising exchange system that receives information from the system, such as information to aid in the auction process. However, the terms integrator networks, third party agents and third party recipients is intended to represent a broad class of entities, including publishers, advertisers and networks, as well as the agents that represent them, that operate on the advertising exchange system.

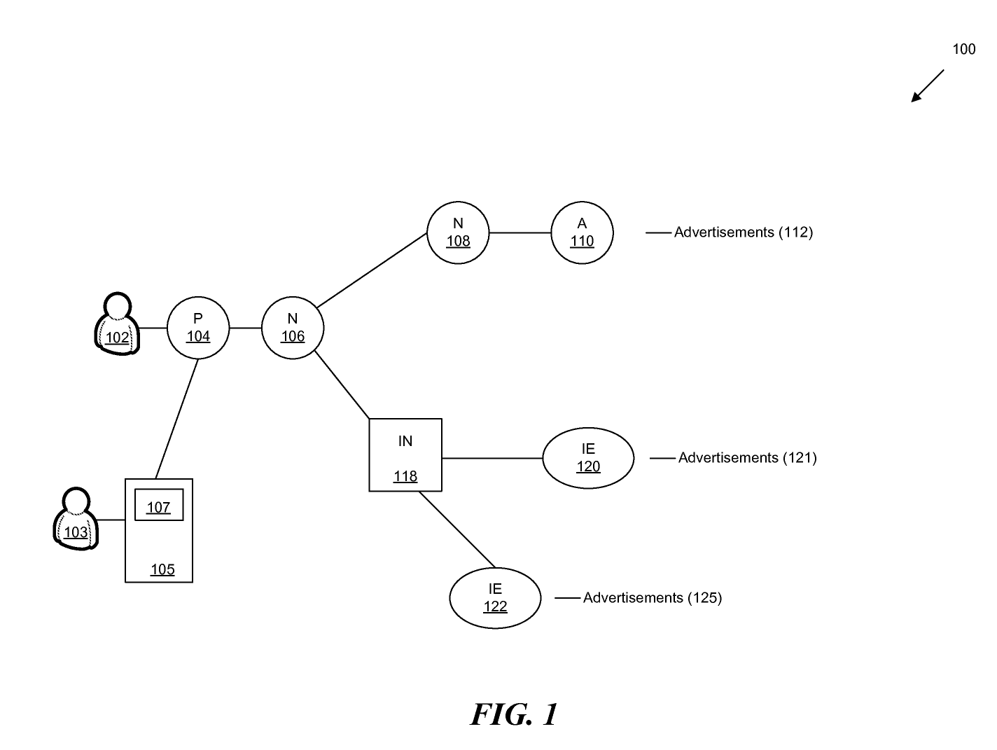

FIG. 1 illustrates one embodiment of an ad delivery system. As shown in FIG. 1, the system 100 includes a variety of entities such as users 102 and 103, one or more publishers 104, networks 106 and 108, and/or advertisers 110. The system 100 further includes one or more integrator networks (IN) 118 that have one or more integrated entities (IE) 120 and 122. The various entities including users, publishers, networks, advertisers, integrator networks and integrated entities illustrated in FIG. 1 are merely exemplary, and one of ordinary skill recognizes that the system 100 may include large numbers of entities. Moreover, the various entities are coupled together in different advantageous configurations such as, for example, the exemplary configuration illustrated in FIG. 1.

The user 103 accesses information and/or content provided by the publisher 104. One form of access may include a browser 105 that has inventory locations 107 for the presentation of advertising. In one embodiment, an ad call is generated that requests an advertisement, from advertisements 112, 120 and 121, for placement with the inventory location 107. The corresponding advertisement may be delivered to publisher 104 by one or more networks. For instance, in one example, the network 106 is coupled to the publisher 104, and the network 108 is coupled to the advertiser 110. For this example, the networks 106 and 108 are coupled to each other. The advertiser 110 generally has one or more ad campaigns each comprising one or more advertisements 112 that the advertiser 110 wishes to place with the inventory of publishers such as, for example, the inventory location 107 of the publisher 104 that is presented to the user 103 via the browser application 105.

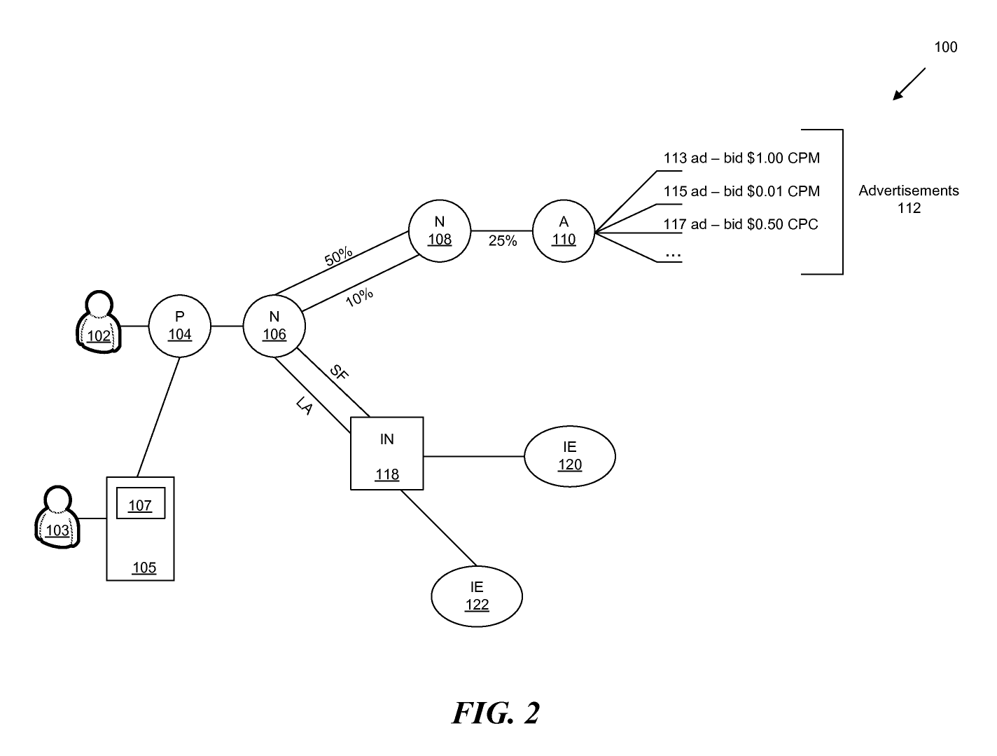

FIG. 2 illustrates another embodiment of an ad exchange system. For this example, the advertisements 113, 115, and 117 generally each have an associated bid that the advertiser 110 will pay for the placement of the advertisement with the inventory and for presentation to the user(s). For this example, the advertisement 113 has a bid of $1.00 cost per thousand page impressions (“CPM”), the advertisement 115 has a bid of $0.01 CPM, and the advertisement 116 has a bid of $0.50 cost per click (“CPC”). One of ordinary skill recognizes different types of bids such as, for example, CPM, CPC, cost per action (“CPA”), and others. Some systems normalize the ad bids to CPM.

For the example illustrated in FIG. 2, the entities along the chain of distribution for the advertisements have various revenue sharing agreements. In this example, the network 108 has a 25% revenue sharing agreement with the network 106 for fees paid by the advertiser 110. Similarly, the network 106 has 50% and 10% revenue sharing agreements with the publisher 104 for fees paid to the network 106 by way of the network 108. The multiple revenue sharing agreements between entities may be for different campaigns and/or for targeting different segments of users. For example, the 50% revenue sharing agreement between networks 108 and 106 may be used to target a user segment that includes males under 40 years old, who have an interest in sports. In another example illustrated in FIG. 2, the 10% revenue sharing agreement may be used to target females, over 30 years old, who have an interest in gardening. For these examples, network 108 delivers users of the target segment to network 106, and network 106 is the exclusive representative of the publisher 104. One of ordinary skill recognizes many different payment and/or targeting schemes.

Alternatively, and/or in conjunction with the embodiments described above, some embodiments direct an ad call for the inventory 107 to an integrator network 118. In one example, the ad call is passed from the network 106 to the integrator network 118 with additional information such as, for example, information regarding a bid amounts for opportunities. In the illustration of FIG. 2, one ad call may have a destination of San Francisco (SF), while another ad call may have a destination of Los Angeles (LA). Based on the ad call and/or information, the integrator network 118 selectively responds to ad calls for, or on behalf of, one or more of its integrated entities 120 and/or 122. The integrated entities 120 and 122 generally include third party entities, such as advertisers, that transact on the exchange by using an intermediary, such as the integrator network 118.

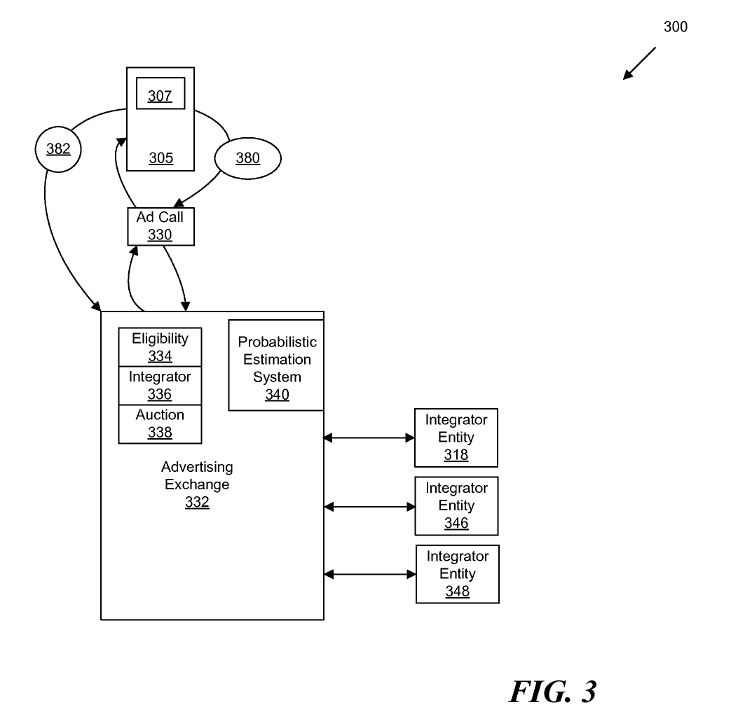

FIG. 3 illustrates another embodiment of an advertisement exchange system. The system 300 includes a browser 305, operating on a computer system, that presents content, including advertising inventory 307, and generates an ad call to the advertising exchange 332. For this embodiment, the system 300 includes an advertising exchange 332 and one or more integrated entities 318, 346 and 348. As mentioned above, the browser 305 and/or inventory 307 require ads and/or generate requests for the presentation of advertisements to a user at various times. One such type of request is in the form of an ad call 330 to the advertising exchange 332. The ad call 330 generally includes a variety of different types of information. In some embodiments, the ad call 330 may include a conventional type ad call for an ad campaign, for a creative and/or for an advertisement that are supplied by a conventional network entity and/or advertiser. The advertising exchange 332 is further capable of receiving additional types of information and/or requests such as, for example, APEX type information 480, RightMedia type information 482, and/or alternative type ad calls such as federated ad calls that contain additional information and/or complexity.

For this embodiment, the ad exchange module 332 includes several modules that provide a variety of functionalities such as, for example, an eligibility module 334, an integrator module 336, and auction module 338. The ad exchange system also includes a probabilistic estimation system 340. The eligibility module 334 determines which entities, including integrator networks and/or integrated entities, are eligible to respond to a particular ad call or to receive a request for an ad bid. The determination may be based on targeting information regarding, for instance, the user, the inventory, the browser, and/or the publisher that are the destination of the requested advertisement. The eligibility module 334 preferably receives targeting, bidding, and/or eligibility information from the ad call 330, and passes information to the entities eligible to bid for the placement of advertising in response to the ad call. Some additional criteria for eligibility that may be used by the eligibility module 334 includes knowledge regarding which entities (e.g., integrator networks) subscribe to a probabilistic estimation service.

Once eligible entities are determined for bidding, the integrator module 336 communicates the information to the integrator networks 318, 346 and 348. The ad exchange system 332 generates one or more ad bid requests for each eligible entity, such as the integrated entities 318, 346 and 348. In one embodiment, the integrator module 336 uses a client-server approach, such as a bid gateway client-server module, located on the ad exchange system 332 (not shown), to communicate with a bid gateway server computer. The bid gateway server computer communicates information, such as opportunities, bid request and estimation information to and from the integrator entities 318, 346 and 348 and the ad exchange system 332.

### The Probability Estimation System:

In practice, the bids are prepared by advertising exchange system 300 over a few milliseconds based on pre-coded instructions from each bidder, although it is acceptable to refer to the bidders themselves as preparing their bid. In preparing their bids, advertisers may choose to use (or not use) a probability estimation system that estimates a bid (i.e., a fair market value for a given impression opportunity).

The choice to use a probability estimation program may not be entirely within the hands of each bidder. In an example, only registered members of advertising exchange system 300 may have access to the probability estimation program. Advertising exchange system 300 may prevent non-members from having access to the probability estimation program without paying a fee or providing some other compensation. Non-members may utilize their own techniques to derive a probability estimation service or function, but their estimation may be lacking since it will not include the rich historic data from advertising exchange system 300.

For purposes of nomenclature, advertising exchange system 300 may designate those bidders who utilize the probability estimation program provided by system 100 as n-bidders. Advertising exchange system 100 may designate those bidders who do not utilize the probability estimation program as k-bidders. To determine the effective CPM bid price for payment methods other than CPM, advertising exchange system 100 may utilize equation (1):

bᵢ=(probability estimation)*(price)*1000 (1)
where,
i=1, . . . , n+k to designate a particular bidder i,
bᵢ=effective CPM bid price for each bidder i, i=1, . . . , n+k,
probability estimation=estimated likelihood of a click or conversion, and
price=advertisers dCPM price, CPC price, CPA price, or return on investment (ROI). goal normalized to CPM price.
   Probability estimation helps determine fair market value for buyers and sellers on every impression, maximizing value for sellers and return for buyers. In general, a probability estimation system, provided by advertising exchange system 300, considers everything advertising exchange system 100 knows about historical performance for a given impression's particular combination of publisher, advertiser, and end user variables. Advertising exchange system 100 may utilize that information to estimate the likelihood that the end user will take an action, such as an advertisement click-through, or perform a predefined action (e.g., conversion) for a given advertisement from the advertiser in view of the Web page content of the publisher. In other words, advertising exchange system 300 utilizes data from a large number of impressions transacted in advertising exchange system 300 to determine a probability estimation amount (conversion rate or probability of conversion). In turn, advertising exchange system 300 uses that probability estimation amount to derive the effective CPM bid price, bᵢ, of the impression for a given advertiser. This CPM bid price may then be used as a bid price in the auction. By taking into account real world data, a probability estimation system 340 ensures that publishers 108, 110, 112 monetize their inventory for the maximum revenue and that advertisers achieve a best possible advertiser return on investment (ROI).

The probability estimation system 340 provides superior conversion rate estimations due to both the hard-to-replicate vast data available from advertising exchange system 300 and the specialized accurate estimation methods of the system. Advertising exchange system 100 generally would expect bidders to benefit from receiving conversion probability information from a probability estimation system since this would allow such bidders to bid in a more informed way to increase their winning probability on average when it is profitable to them. While advertising exchange system 300 generally would expect bidders to benefit from receiving conversion probability information from a probability estimation system, it is desirable to put a value to that benefit since advertising exchange system 300 may utilize this value in a variety of ways. For example, advertising exchange system 300 may utilize the derived value to place a price on the probability estimation service based on a percentage of the value. In addition, advertising exchange system 300 may utilize the derived value to market the probability estimation service to members and non-members of exchange 300.

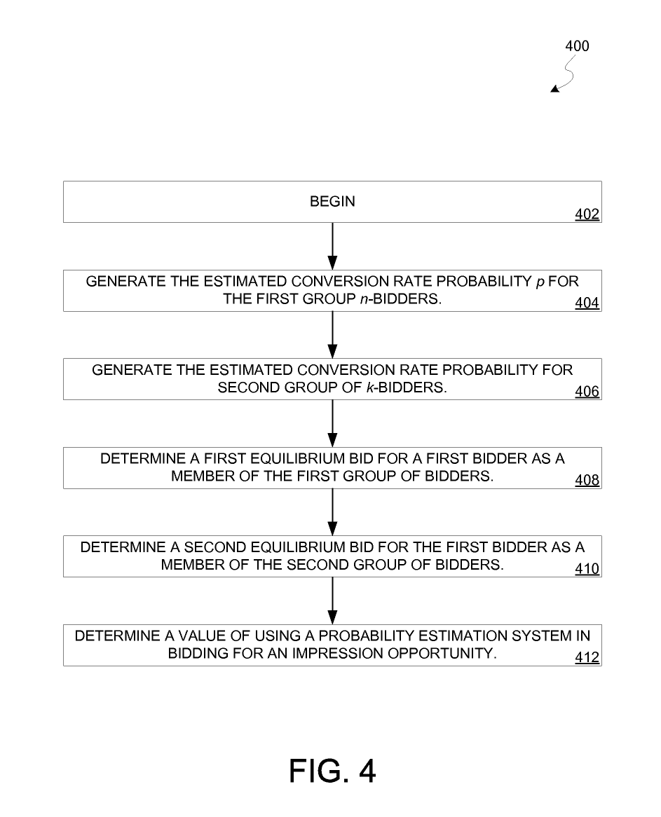

FIG. 4 is flow diagram illustrating a process 400 to value usage of a probability estimation system within an advertising exchange system. Probability estimation system 340 may be a computer-implemented method, operating with a processor and memory, to determine a value of using probability estimation in bidding for an impression opportunity over not using probability estimation in bidding for that same impression opportunity. Probability estimation system 340 may utilize a numerical value output of process 400 to inform a bidder of a monetary benefit of utilizing conversion rate information. Later discussion provides details regarding the usage of the value to determine a price for usage of the probability estimation system 340 provided in advertising exchange system 300.

Process 400 may begin, at processing block 402, by establishing the players/bidders, rules related to them, and compiling information about them. For example, an advertising exchange system 340 may make services provided by a probability estimation system available to some bidders (n-bidders) and not to others (k-bidders). For example, the advertising exchange system 300 may make the services provided by the probability estimation system available to members of advertising exchange system 100, whereas non-members may have general access to advertising exchange system 100 but lack access to the probability estimation system 340.

For purposes of explanation, “n” bidders are defined as a first group of bidders that utilizes the probability estimation system. In addition, “k” bidders, defined in a second group, are bidders that do not utilize the probability estimation system. The sum of n+k may represent the total number of bidders, TB, for any one impression opportunity such that

TB=n+k (2)
where,
TB=the total number of bidders i for any one impression opportunity,
n=the number of bidders who are part of a first group utilizing the Probability estimation system, and
k=the number of bidders who are part of a second group that does not utilize the probability estimation system.
   Each bidder, “i”, may be backing the success of one advertisement for service to that impression opportunity. A total number of bidders (n+k) for an impression opportunity may typically range from 2,000 to 30,000 out of 930,000 advertisers' campaigns active in the exchange system 300, but process 400 may handle numbers well outside that example range.

The advertising exchange system 300 may find it desirable to inform the k-bidders of the second group as to the value of the probability estimation system may have in their effort to advertise. Advertising exchange system 300 may utilize that information as part of a marketing campaign to acquire new members or as part of a feel-good campaign to show that the probability estimation system stands out as the clear choice in a sea of choices and to let non-member subscribers see the service in terms of its value to them. Alternatively, advertising exchange system 300 may find it desirable to sell usage of the probability estimation system to the k-bidders, and the sale price may be a function of the value of the probability estimation system to a particular k-bidder.

Process 400 employs auction theory. Auction theory is an applied branch of game theory that deals with how people act in auction markets and researches the game-theoretic properties of auction markets. Klemperer, P. (1999, July). Auction theory: A guide to the literature. Journal of Economic Surveys 13 (3), 227-286, is part of the broad literature in auction theory. There are traditionally four types of auctions that are used to allocate a single item: (i) first-price sealed-bid auctions (Sealed tender auctions), (ii) second-price sealed-bid auctions (Vickrey auctions), (iii) open ascending-bid auctions (English auctions), and (iv) open descending-bid auctions (Dutch auctions). In first-price sealed-bid auctions, bidders place their bid in a sealed envelope and simultaneously hand them to the auctioneer. The auctioneer opens the envelopes and the individual with the highest bid wins, usually paying a price equal to the exact amount that he or she bid. Although process 400 may preferably be applied a first-price sealed-bid auction, process 400 may be applied in other auction types.

In the bidding process, the bidders may bid in a single shot, first price sealed-bid equivalent auction for the advertising opportunity. Their bid reflects their personal, subjective valuation of the advertising opportunity based on the information available to them and each valuation reflects an amount that each bidder considers a fair equivalent for the advertising opportunity. The bidder who submits the highest bid wins the right to serve an advertisement to the advertisement opportunity.

In general, bidder i values the advertising opportunity at vᵢ, which is private information to her. However, each bidder is aware that each valuation, vᵢ, is independently drawn from the same continuous distribution F(v) on [v, v̅] with density ƒ(v) where F(v)=0, F(v)=1. In other words, there are n+k bidders whose valuations, vᵢ, i=1, . . . , n+k, for the advertisement opportunity are independent and identically-distributed (i.i.d.) random variables with support [0,1], probability density function (p.d.f.) ƒ, and cumulative distribution function (c.d.f.) F. Advertising exchange system 300 may presume that each bidder i is risk neutral in that each bidder i may be indifferent between receiving $1 and taking a risky bet with an expected value equal to $1.

From equation (1) above, where bᵢ=(probability estimation)*(price)*1000, it is clear that the probability estimation plays an important roll in the bid bᵢ submitted by each bidder i. The n-bidders have access to the probability estimation system provided by advertising exchange system 100 and may use that service as their probability estimation. In this example, p may denote the estimated conversion rate probability for the advertising opportunity as derived by the probability estimation system of advertising exchange system 300. However, the k-bidders provide their own guesses about the conversion rates utilizing third party information (3PI), where the third party information may be information other than that utilized by advertising exchange system 300, to derive p.

The k-bidders are at a disadvantage to the n-bidders since the accuracy of each k-bidder guess at the probability estimation is inferior to that provided by the probability estimation system in most cases. There are several reasons for this, including the hard-to-replicate vast data availability of advertising exchange system 300 as well as the development of specialized accurate estimation methods that are part of advertising exchange system 300. Therefore, the n-bidders benefit from receiving the conversion probability information from the system 300, in most cases. Conversely, the k-bidders bid in a less informed way, and thus on-average decrease their winning probability. To reflect this disadvantage, process 400 may assign an offset to the estimated conversion rate probability of each k-bidder.

In this example, sⱼ may denote the estimated conversion rate probability for the advertising opportunity as derived by a k-bidder. Here, the outside k-bidders each may have their own probability estimation, denoted by

sⱼ=p+εⱼ, (3)
where,
j=1, . . . , k to designate a particular k-bidder,
p=the true action (e.g. click/conversion) probability of the advertising opportunity
εⱼ=the epsilon offset or amount by which the probability estimation of a particular k-bidder deviates from an optimal probability estimation p provided by the Probability estimation system; the noise term in the system's probability estimation; there are k bidders where each epsilon offset εⱼ,j=1, . . . , k, for the advertisement opportunity is an independent and identically-distributed (i.i.d.) random variable with a probability density function lowercase phi, (p.d.f.) φ, a cumulative distribution function uppercase phi, (c.d.f.) Φ, an expected value equal to zero, E[εⱼ]=0, and a variance equal to the square of the standard deviation sigma, Var[εⱼ]=σ², and
sⱼ=a probability estimation signal provided by k-bidder j to advertising exchange system 100.

At processing block 404, advertising exchange system 300 may generate the estimated conversion rate probability π (an estimate of p) for the first group n-bidders. At processing block 406, each k-bidder, as a member of a second group of bidders, may generate an estimated conversion rate probability signal sⱼ (estimate). As noted, each second group k-bidder may utilize third party information to derive its own probability estimation.

Nash equilibrium is a solution concept of an auction involving two or more bidders i, in which the auction assumes that each bidder i knows the equilibrium strategies β of the other bidders, and no bidder has anything to gain by changing only his or her own strategy βᵢ unilaterally. If each bidder i has chosen a strategy βᵢ and no bidder can benefit by changing his or her strategy while the other bidders keep theirs unchanged, then the current set of strategy choices and the corresponding payoffs constitute a Nash equilibrium. An equilibrium bid is a bid that contributes to the Nash equilibrium and is contributed to advertising exchange system 100 in equilibrium.

At processing block 214, advertising exchange system 300 may determine a first equilibrium bid bᵢ* for a first bidder as a member of the first group of n-bidders. Here, advertising exchange system 300 presumes that all other bidders stay in the group they belong and that the first bidder is a member of the first group of bidders. As noted, each first group of n-bidders utilized the probability estimation system 340 to derive a probability estimation that is common to each n-bidder. At processing block 410, advertising exchange system 300 may determine a second equilibrium bid bᵢ* for the first bidder as a member of the second group of k-bidders. Here, advertising exchange system 300 presumes that all other bidders stay in the group they belong and that the first bidder is a member of the second group of bidders.

Once advertising exchange system 300 determines the equilibrium bids for the first bidder as a member of each group of bidders, advertising exchange system 300 may utilize the first equilibrium bid and the second equilibrium bid to determine at processing block 412 a value of using the probability estimation system in bidding for an impression opportunity within advertising exchange system 300 over not using that probability estimation system. In other words, advertising exchange system 300 may determine the expected return of using the probability estimation system 340 for any third party k-bidder.

Equilibrium Bid bᵢ*

First-price sealed-bid auctions are auctions in which the highest bid wins and the highest bidder pays a price equal to her bid. If two or more bidders make the same highest bid, then system 300 may award the advertising opportunity to one of the high bidders at random. Alternatively, if the bidders are sellers vying for a single advertisement, a standard sealed-bid auction is one in which the low bidder wins and receives the corresponding price. A skilled person may adapt process 300 to apply to bidders that are sellers.

Symmetric equilibrium in an auction is a type of equilibrium where each bidder uses the same strategy (possibly mixed) in the equilibrium. Only symmetric equilibria can possess an evolutionarily stable state in single population models. Advertising exchange system 100 utilizes symmetric equilibrium in each auction, that is, a real number R in an equilibrium strategy β: [0,1]→{0}∪(R,∞) such that the symmetric strategy profile (β, . . . , β) is a Nash equilibrium.

To determine the equilibrium bid for each bidder at processing blocks 408-410, advertising exchange system 300 first may resolve the collective of the probability estimation signals sⱼ into a vector s (bolded character s) such that:

s=(s₁, . . . ,sₖ), j=1, . . . ,k (4)
where,
s=the vector of signals sⱼ for group two k-bidders, and
sⱼ=a probability estimation signal provided by k-bidder j to advertising exchange system 100.

Each bidder i will provide a bid bᵢ that utilizes a real value R such that:

b*(p,s):R₊^{k+1}→R₊^{+k} (5)
where,
   p=an optimal probability estimation provided by the Probability estimation system of advertising exchange system 100,
   s=the vector of signals sⱼ for group two k-bidders,
   b*(p,s)=an equilibrium bid vector for a given bidder i,
   k=the number of bidders who are part of a second group lacking access to the Probability estimation system,
   n=the number of bidders who are part of a first group utilizing the Probability estimation system,
   R=a real value number,
   R₊^{k+1}→R₊^{n+k}=the domain and the range of bidding equilibrium function, b*. The domain is the positive orthant of the k+1 dimensional Euclidian space. An element of this domain is a k+1 vector comprised of the probability estimate p and each one of the signals of the k bidders in the second group. The range is the positive orthant of the n+k dimensional Euclidian space. An element of this domain is an n+k vector comprised of the bids of all n+k bidders.

To determine the equilibrium bid bᵢ for the i^{th} second group k-bidder, advertising exchange system 300 may apply equation (6):

$${b}_{i}^{*} = arg {max}_{b} E [ ( p \cdot {v}_{i} - b ) \vert {s}_{i} ] {F}_{( 1 )}^{n} ( {β}_{1}^{- 1} ( b ) ) {F}_{( 1 )}^{k - 1} ( {β}_{2}^{- 1} ( b ) \vert {s}_{i} ) \qquad ( 6 )$$

where,
*=denotes equilibrium,
i=a generic index identifying the bidder i,
bᵢ=effective CPM equilibrium bid for each second group k-bidder i, i=1, . . . , n+k,
arg max=stands for the argument of the maximum, that is to say, the set of points of the given argument for which the value of the given expression attains its maximum value,
E[(p·vᵢ−b)|sᵢ]=the difference between the expected value of the revenue a bidder can make from the impression auctioned (p·vᵢ) and the bid (b) given sᵢ,
sᵢ=a probability estimation signal provided by k-bidder i to advertising exchange system 100,
β₁=the equilibrium strategy function in a symmetric equilibrium for n-bidders accessing the Probability estimation system of advertising exchange system 100,
β₂=the equilibrium strategy function in a symmetric equilibrium for k-bidders lacking access to the Probability estimation system of advertising exchange system 100,
F₍₁₎ⁿ(β₁⁻¹(b))=the probability distribution function of the first order statistic out of n draws of the inverse of the equilibrium bid function for a given b value. Equals the probability that the bids of all n first group members bid lower than the i^{th} bidder. and
F₍₁₎^{k-1}(β₂⁻¹(b)|sᵢ=the probability distribution function of the first order statistic out of k−1 draws of the inverse of the equilibrium bid function for a given b value given sᵢ. Equals the probability that the bids of all remaining k−1 second group members bid lower than the i^{th} bidder conditional on sᵢ.

To determine the equilibrium bid δⱼ for the j^{th} first group n-bidder at processing block 216, advertising exchange system 100 may apply equation (7):

$${b}_{i}^{*} = arg {max}_{b} E [ ( p \cdot {v}_{i} - b ) \vert π ] {F}_{( 1 )}^{n - 1} ( {β}_{2}^{- 1} ( b ) ) {F}_{( 1 )}^{k} ( {β}_{2}^{- 1} ( b ) ) \qquad ( 7 )$$

where,
*=denotes equilibrium,
bᵢ*=effective CPM equilibrium bid for each second group n-bidder j, j=1, . . . , n,
arg max=stands for the argument of the maximum, that is to say, the set of points of the given argument for which the value of the given expression attains its maximum value,
E[(p·vᵢ−b)|π]=the difference between the expected value of the revenue a bidder can make from the impression auctioned (p·vᵢ) and the bid (b) given π,
π: π=p+ε, where π is the optimal estimation of p provided by the Probability estimation system of advertising exchange system 100,
p=the true action (e.g. click/conversion) probability of the advertising opportunity,
ε=is the noise term in the system's probability estimation,
β₁=the equilibrium strategy function in a symmetric equilibrium for n-bidders accessing the Probability estimation system of advertising exchange system 100,
β₂ the equilibrium strategy function in a symmetric equilibrium for k-bidders lacking access to the Probability estimation system of advertising exchange system 100,
F₍₁₎ⁿ⁻¹(β₁⁻¹(b))=The probability distribution function of the first order statistic out of n draws of the inverse of the equilibrium bid function for a given b value. Equals the probability that the bids of all n first group members bid lower than the i^{th} bidder, and
F₍₁₎^{k}(β₂⁻¹(b))=The probability distribution function of the first order statistic out of k−1 draws of the inverse of the equilibrium bid function for a given b value. Equals the probability that the bids of all remaining k−1 second group members bid lower than the i^{th} bidder.

Advertising exchange system 300 may determine the vector equilibrium bids for all bidders b* by applying equation (8):

b*=(b₁*,b₂*, . . . , bₙ₊ₖ*) (8)
where,
*=denotes equilibrium, and
b*=is the vector equilibrium bids for all bidders. Denote the corresponding p.d.f. and c.d.f. of the l^{th} order statistic for a distribution with (l).
bₙ₊ₖ*=effective CPM equilibrium bid for all bidders—both first group n-bidders and second group k-bidders—such that i=1, . . . , n+k.

Value of Using a Probability Estimation System

The equilibrium can be obtained by solving equations (6)-(7) for all j=1, . . . , n and i=n+1, . . . , n+k:

bᵢ*−bⱼ*=arg max_{B}E[(p·vᵢ−b)|sᵢ]F₍₁₎ⁿ(β₁⁻¹(b))F₍₁₎^{k-1}(β₂⁻¹(b)|sᵢ)−arg max_{b}E[(p·vᵢ−b)|p]F₍₁₎^{k-1}(β₁⁻¹(b))F₍₁₎^{k}(β₂⁻¹(b)) (9)

After obtaining equilibrium bids bᵢ* at processing block 408 and equilibrium bids bⱼ* at processing block 410, advertising exchange system 300 may determine at processing block 412 a value of using the probability estimation system in bidding for an impression opportunity over not using that probability estimation system. In other words, advertising exchange system 300 may determine the expected return of using the probability estimation system for the i^{th} third party bidder according to equation (10):

Δ(n,k)=E_{v,p,π[(}pv−bⱼ^{n+1,k-1}(π))|π]−E_{v,p,s}[(pv−bⱼ^{n,k}(s))|sᵢ] (10)
where,
   n=the number of bidders who are part of a first group of n-bidders utilizing the Probability estimation system,
   k=the number of bidders who are part of a second group of k-bidders lacking access to the Probability estimation system,
   Δ(n,k)=a value of the Probability estimation system service to the i^{th} second group k-bidder,
   p=the true action (i.e. click/conversion) probability of the advertising opportunity,
   π=an optimal estimation of p provided by the Probability estimation system of advertising exchange system 100,
   bᵢ=effective CPM bid price for each bidder i, i=1, . . . , n+k,
   v=The expected revenue for a given bidder from the auctioned impression provided that a consumer clicks (or completes a purchase) using the ad,
   s=The estimate for the probability of click or purchase by a bidder in the second group,
   E_{v,p,π}[(pv−bⱼ^{n+1,k-1}(π))|π]=Expected profit for a second group bidder when he purchases the information from the system and becomes a first group bidder, and
E_{v,p,s}[(pv−bⱼ^{n,k}(sᵢ))|sᵢ]=Expected profit for a second group bidder when he does not purchase the information and stays as a second group bidder.

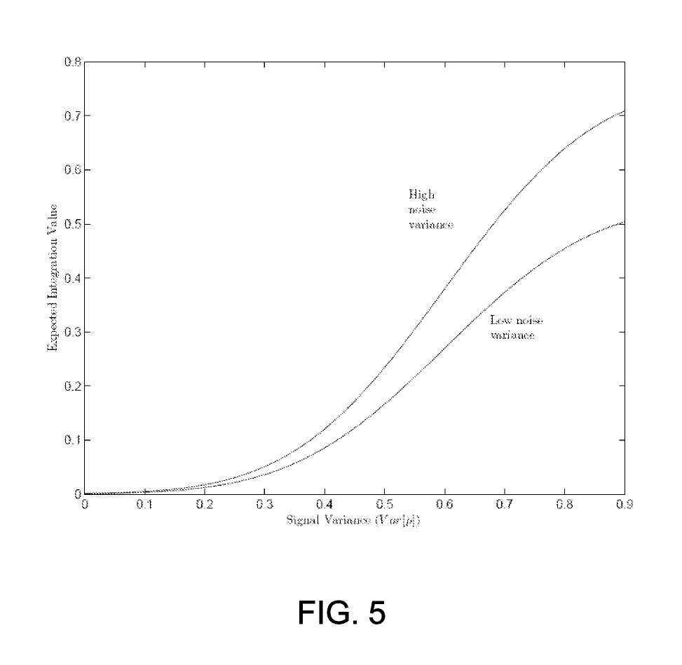

FIG. 5 is line chart illustrating the effect of signal and noise variances on calculation of integration value for a second group of k-bidders. Increasing the signal and noise variances results in increases in the value of the integration.

### Pricing Usage of a Probability Estimation System

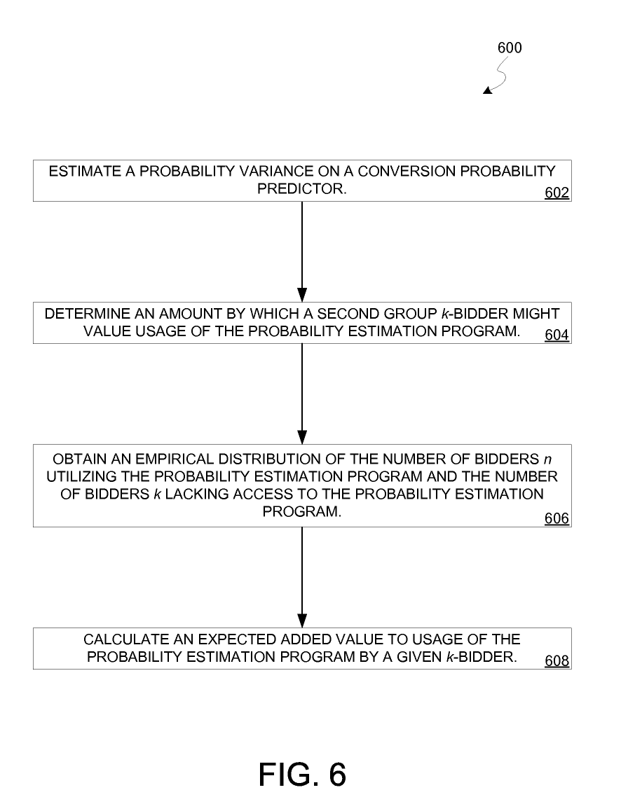

FIG. 6 illustrates a process 600 to price usage of a probability estimation system in bidding for an impression opportunity within advertising exchange system 300. Advertising exchange system 300 may view price as an amount of money or another numerical monetary value needed to purchase usage of a probability estimation system. Advertising exchange system 300 may utilize user behavior and auction data available to it to estimate and price a service of data and packaged algorithm provision.

At processing block 602, advertising exchange system 300 may estimate a probability variance on a conversion probability estimator by using a probability variance estimator. An example probability variance estimator may include a logistic regression model. A logistic regression model may estimate the probability of occurrence of an event by fitting data to a logistic curve. As a generalized linear model used for binomial regression, logistic regression may utilize several estimator variables that may be either numerical or categorical. A conversion probability estimator may help a bidder determine a probability that a user will mouse over, click on, make a purchase, or engage in some other conversion through the advertisement. The probability variance may reflect a difference between an estimated probability and the actual probability experienced.

At processing block 604, advertising exchange system 100 may utilize the probability variance determined in processing block 602 to determine an amount by which a second group k-bidder might value usage of the probability estimation system 340. Advertising exchange system 300 may utilize equation (10) above—E_{v,p,π[(pv-b}ⱼ^{n+1,k-1}(π))|π]−E_{v,p,s}[(pv−bⱼ^{n,k}(s))|sᵢ]—to make this determination for any given n, and k, assuming Var[ε]=∞. Advertising exchange system 300 may utilize this amount as an upper bound on the price that may be charged to a k-bidder for integration for the given n and k values.

At processing block 606, advertising exchange system 300 may obtain an empirical distribution of the number of bidders, n, utilizing the probability estimation system 340 and the number of bidders k lacking access to the probability estimation system 340 using exchange data. As noted, n reflects the number of bidders who are part of a first group of n-bidders utilizing the probability estimation system. Moreover, k reflects the number of bidders who are part of a second group of k-bidders lacking access to the probability estimation system. The empirical distribution may be a cumulative probability distribution that, in a draw of N samples, concentrates probability 1/N at each of the N numbers in a sample.

At processing block 608, advertising exchange system 300 may calculate an expected added value or benefit to usage of the probability estimation system 340 by a given k-bidder. The expected added value may be a value attributed to the probability estimation system 340 service in view of a particular bidding process. Advertising exchange system 300 may utilize the empirical distribution from processing block 606 and the amount determined from processing block 604 to calculate added value expected by advertising exchange system 300. Advertising exchange system 300 may utilize the expected added value as an upper bound to the amount charged to the third party k-bidder for integration by exchange 300.

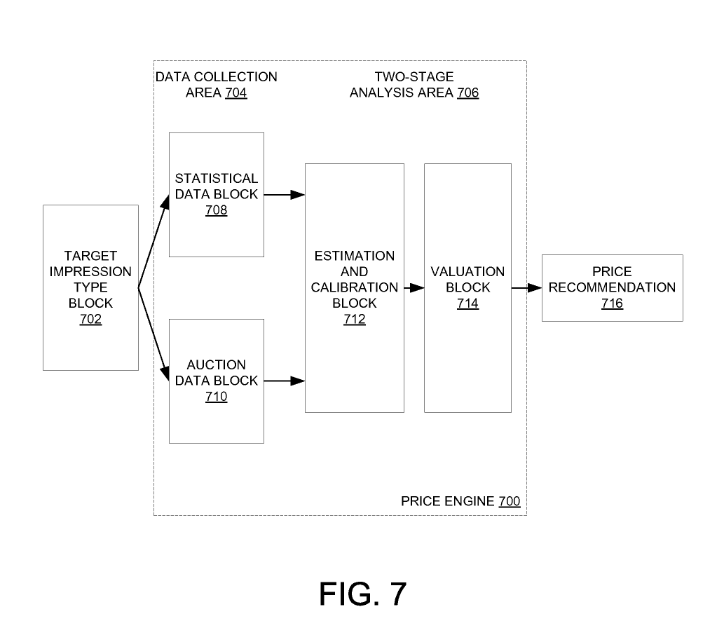

FIG. 7 is a block diagram that may serve as part of a price recommendation engine 700 through data analysis. At block 702, the advertising exchange system may determine target impression types. A target impression type may include user demographics and information about certain web properties of the impression opportunity seller, among other data. The inquiry may be part of a campaign or part of a single target inquiry.

Advertising exchange system may divide engine 700 into a data collection area 704 and a two-stage analysis area 706. Data collection area 704 may include a statistical data block 708 and an auction data block 710. Statistical data block 708 may generate statistical data on the estimator from the probability estimation system, such as estimator variance. Auction data block 710 may generate auction data from advertising exchange system, such as the number of bidders that use the probability estimation system, the number of bidders that do not use the probability estimation system, and information about their historical bids. Both statistical data block 708 and auction data block 710 may receive information about target impression types from block 702 and pass information into two-stage analysis area 706.

Two-stage analysis area 706 may include an estimation and calibration block 712 and a valuation block 714. Estimation and calibration block 712 may receive data from both statistical data block 708 and auction data block 710 and use that data to estimate model parameters. Estimation and calibration block 712 may use that estimation to calibrate the model. In the second stage of analysis area 706, valuation block 714 may receive an output of estimation and calibration block 712 and run simulations for the equilibrium. Engine 700 may run the simulations through valuation block 714 with and without the agent having the information from the price estimation program. Valuation block 714 then may generate an estimated distribution for the marginal value that the price estimation program information provides to the agent and output that estimate as a price recommendation 716. Here, price producing engine 700 may seamlessly integrate the three stages of (i) data collection, (ii) empirical estimation and model calibration, and (iii) valuation through numerical equilibrium simulations.

Advertising exchange system 300 may generate and retain a significant amount of data. For example, advertising exchange system 300 may have information on the number of bidders for each auction and the number of bidder utilizing a probability estimation system for a given auction. That information may be utilized to calibrate the valuation model of equation (10), namely E_{v,p,π[(pv-b}ⱼ^{n+1,k-1}(π))|π]−E_{v,p,s}[(pv−bⱼ^{n,k}(s))|sᵢ], when that model is applied to a case of dCPM bidders.

The implemented auction can be an equivalent of a first-price or second-price auction. Within the class of first- or second-price, sealed-bid auctions, there are a number of possible variations in environment, information, and rules. For example, there may be no reservation price, so that the auction will definitely sell the item, or there may be a reservation price that is announced or unannounced in advance of the auction. In addition, the number of potential bidders is unknown with a distribution that is common knowledge. The below discussion first considers an analysis with fixed number of bidders of each type. Then, the discussion considers uncertainty on the number of bidders from the point of view of a dCPM bidder.

Pricing Usage a Probability Estimation System Given a Fixed Number of Bidders from Participant Types

Consider n members and k non-members participating in an auction by making dCPM bids with reduced pricing. For the discussion purposes, assume that members n of advertising exchange system 100 utilize a Probability estimation system provided by utilizing equation (10), namely E_{v,p,π}[(pv−bⱼ^{n+1,k-1}(π))|π]−E_{v,p,s}[(pv−bⱼ^{n,k}(s))|sᵢ], advertising exchange system 100 may denote a valuation vector v of the n+k bidders as

v=(v₁, . . . , vₙ₊ₖ) (11)
where
   v=a valuation vector, and
   vᵢ=represents the expected net gain of the bidder i for i=1, . . . , n+k if a conversion actually takes place. This conversion may be a click or a purchase, for example. In an example, differences in the conversion type do not have an effect on the solution.

In equation (11), vᵢ is an independent and identically-distributed (i.i.d.) random variable with U[v, v̅]. However, the example may extend to a correlated valuation situation. Recall that p designates an optimal probability estimation provided by the probability estimation system of advertising exchange system 300. Here, the expected or ex-ante distribution of the conversion rate p may be U[p, p̅]. In addition, advertising exchange system 1300 may supply members with a probability estimation s according to equation (12):

π=p+ε, with ε distributed as U[ε, ε̅] (12)
where,
   p=the true (average) conversion probability for the advertisement,
   ε=the noise in the system's estimate of the true conversion probability and
   π=a probability estimation provided by the Probability estimation system of advertising exchange system 100 to the first group bidders.

Advertising exchange system 300 supplies each member bidder n with the probability estimate π. A Bayesian inference or update is statistical inference in which a system utilizes evidence or observations to update or to infer anew the probability that a hypothesis may be true. Accordingly, member bidder n has a Bayesian update on her expected valuation of the impression as vᵢ·π. Correspondingly, the valuation estimate from each non-member bidder is vᵢ·E[p]. Bidding takes place for the impression opportunity. The winner is the bidder with the highest bid and she pays a reduced price equal to a “tick” above the second highest bid. Advertising exchange system 300 may calculate an upper bound on the price for the probability estimation service by calculating an upper bound of the value of having the estimation ofp for a non-member bidder k, and being able to bid in an informed way, as described above using these distributional parameters.

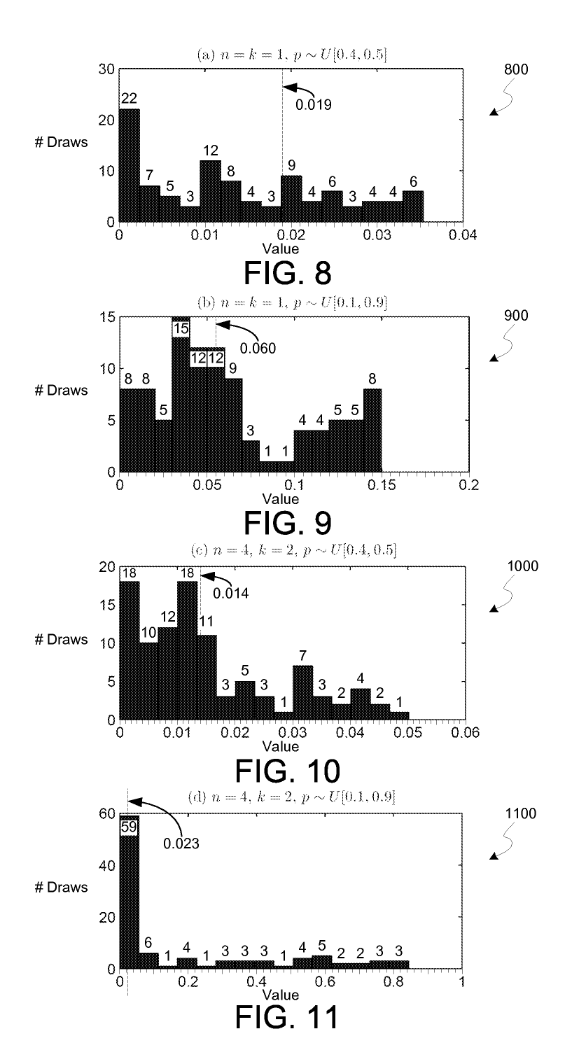

FIG. 8 is a bar chart that illustrates a histogram 800. In histogram 800, p˜U[0.4,0.5] and the fixed number of bidders is two, with one n-bidder utilizing the probability estimation system and one k-bidder lacking access to the probability estimation system. Also, v==4, v̅=5, and ε̅= ε̅=0. Histogram 800 represents a frequency distribution of the average marginal value a non-member k-bidder may expect to gain from obtaining a conversion rate or probability estimate from the probability estimation system. Histogram 800 displays 100 draws from a simulation calculating the average value difference using two-million auction realizations. The heights of each bar represents the number or frequency of draws observed at a given value.

Advertising exchange system 300 may determine a price to charge to the one k-bidder by applying a benchmark as a standard by which advertising exchange system 300 may measure or judge something. For example, advertising exchange system 300 may utilize a mean marginal valuation difference coming from the simulation outcome since it gives an unbiased estimate of the expected ex ante valuation, making it a “fair” price per auction that a risk-neutral non-member may be willing to pay. In histogram 800, the mean marginal valuation is 0.019. Alternatively, advertising exchange system 300 may utilize the maximum marginal value realization in the distribution from the simulation outcome since it serves as a looser but more conservative upper bound on the price per auction that may be charged.

FIG. 9 is a bar chart that illustrates a histogram 900. The input to histogram 900 differs from histogram 600 in that p˜U[0.1,0.9] rather than p˜U[0.4,0.5]. In histogram 900, the mean marginal valuation is 0.060. FIG. 10 is a bar chart that illustrates a histogram 1000. The input to histogram 1000 differs from histogram 800 in the fixed number of bidders is six, with four n-bidders utilizing the probability estimation system and two k-bidders lacking access to the probability estimation system. In histogram 1000, the mean marginal valuation is 0.014. FIG. 11 is a bar chart that illustrates a histogram 1100. The input to histogram 1100 differs from histogram 800 in two ways. First, p˜U[0.1,0.9] rather than p˜U[0.4,0.5]. In addition, the fixed number of bidders is six, with four n-bidders utilizing the probability estimation system and two k-bidders lacking access to the probability estimation system. In histogram 1100, the mean marginal valuation is 0.023.

### Pricing Using a Probability Estimation System Given Uncertainty on the Number of Bidders on Each Type

This analysis considers an unknown or at least an uncertainty in the number of bidder participants of each type in an auction from the perspective of a non-member k-bidder making dCPM bids with reduced pricing. Here, the analysis supplies a full value distribution evaluation for a potential non-member bidder who may be considering purchase of the probability estimation system.

Advertising exchange system 300 may use data collected from exchange 100 on auctions to derive an empirical distribution of the number of each type of bidder for a given auction. Advertising exchange system 300 may use this ex-ante distribution of the number of bidders as the probability distribution of each type of competitor from the point of view of a non-member k-bidder. Here, advertising exchange system 100 may denote the probability of n and k to equal the particular values of \hat{n} and \hat{k} (from the corresponding discrete distributions) by φₙ(\hat{n}), and φₖ(\hat{k}), respectively.

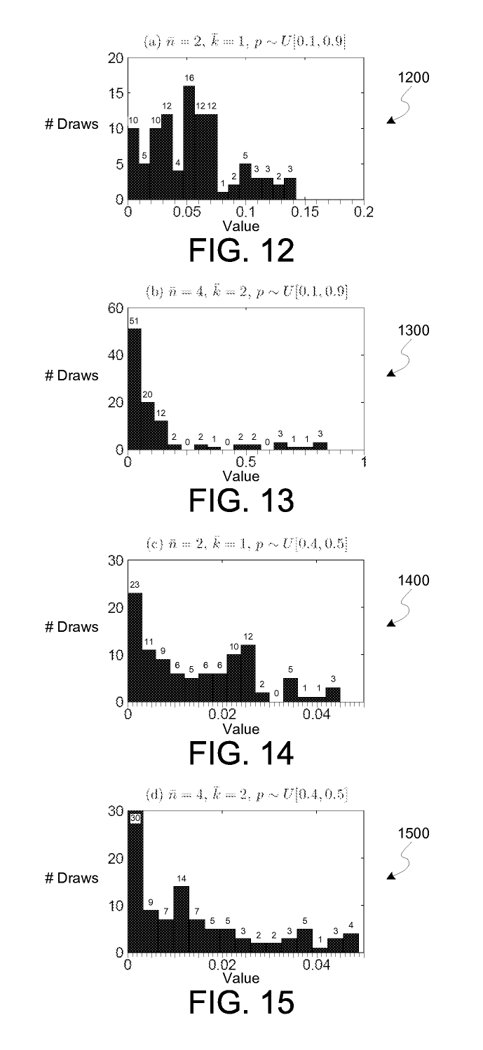

FIG. 12 is a bar chart that illustrates a histogram 1200. FIG. 13 is a bar chart that illustrates a histogram 1300. FIG. 14 is a bar chart that illustrates a histogram 1400. FIG. 15 is a bar chart that illustrates a histogram 1500.

In histogram 1200, p˜U[0.1,0.9], n̅=2, and k̅=1 Also, v=4, v̅=5, and ε= ε̅=0. Histogram 1200 represents outcomes of pricing as a frequency distribution of the average marginal value a non-member k-bidder may expect to gain from obtaining a conversion rate or probability estimate from the probability estimation system. Histogram 1200 displays 100 draws from a simulation calculating the average value difference using two-million auction realizations for n, and k values chosen from discrete uniform distributions with supports on integer intervals [1, n̅] and [1, k̅], respectively. The heights of each bas represent the number or frequency of draws observed at a given value. Histograms 1300-1500 have similar characterizations except as noted in the figures.

A discrete uniform distribution is a discrete probability distribution characterized by saying that all values of a finite set of possible values are equally probable. A discrete space is a particularly simple example of a topological space or similar structure, one in which the points are “isolated” from each other in a certain sense. The truncated normal distribution is the probability distribution of a normally distributed random variable whose value is bounded either below or above (or both). Here, φₙ and φₖ are discrete uniform and truncated normal distributions. Advertising exchange system 100 may impute into the analysis any empirical distribution obtained from auction data provided by advertising exchange system 300. The particular price to be charged may be determined based on a preferred conservativeness of the estimate such as the empirical mean from the simulation outcome.

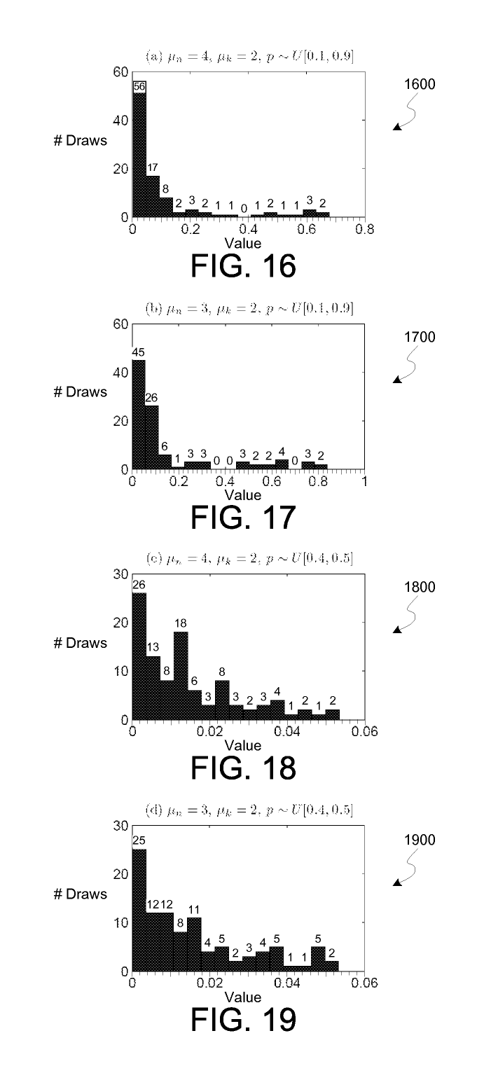

FIG. 16 is a bar chart that illustrates a histogram 1600. FIG. 17 is a bar chart that illustrates a histogram 1700. FIG. 18 is a bar chart that illustrates a histogram 1800. FIG. 19 is a bar chart that illustrates a histogram 1900.

In histogram 1600, p˜U[0.1,0.9], μₙ=4, and μₖ=2. Also, v=4, v̅=5, and ε= ε̅=0. Histogram 1600 represents outcomes of pricing as a frequency distribution of the average marginal value a non-member k-bidder may expect to gain from obtaining a conversion rate or probability estimate from the probability estimation system. Histogram 1600 displays 100 draws from a simulation calculating the average value difference using two-million auction realizations for n, and k values chosen from discretized truncated normal distributions with variance 1, and means μₙ and μₖ, and supports on integer intervals [1,2μₙ−1] and [2μₖ−1] respectively. The heights of each base represent the number or frequency of draws observed at a given value. Histograms 1700-1900 have similar characterizations except as noted in the figures.

Expansion

Advertising exchange system 300 may utilize the above methodologies and tools to price the provision of information services, such as CPC and CPA conversion rate estimates from a probability estimation system. A skilled person may expand these methodologies and tools to apply and fine-tune them to a small number of highly liquid auctions without departing from the scope of the discussion as well extend them to all suitable auctions consequently. In general, the disclosed price engine is highly scalable and advertising exchange system 100 can apply the price engine to most, if not all, of the auction types in advertising exchange system 100.

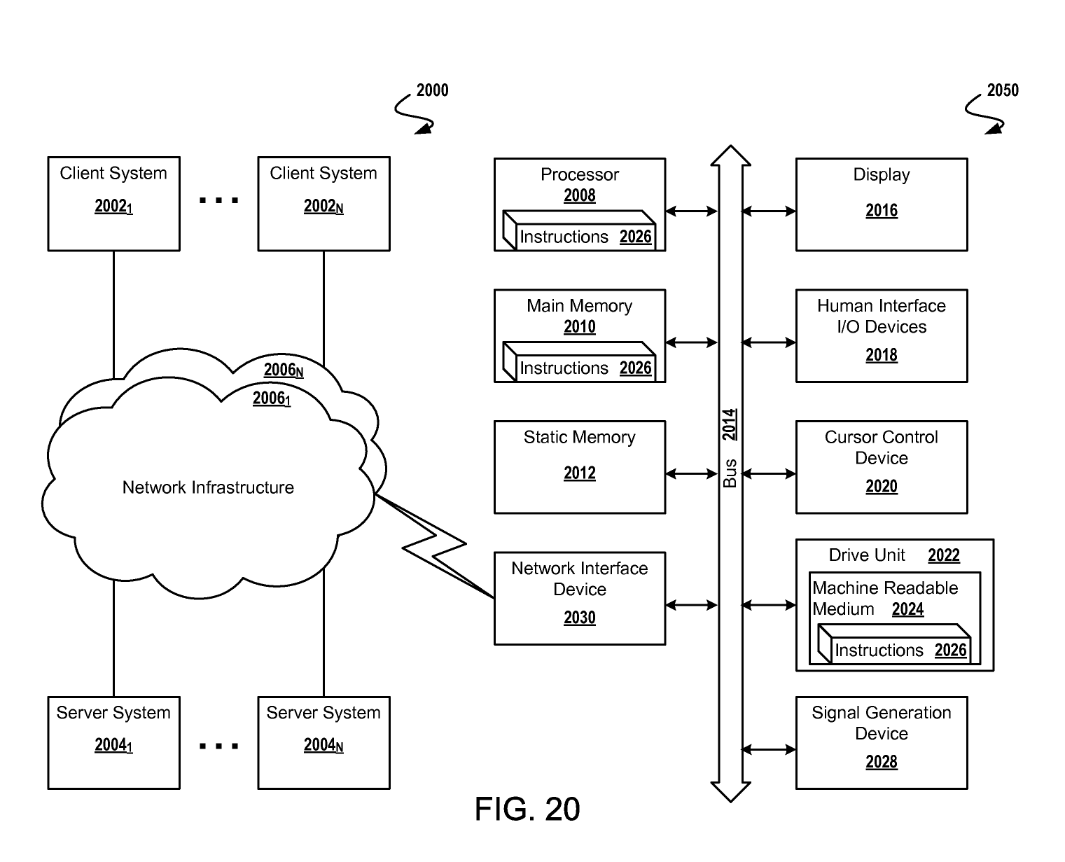

FIG. 20 is a diagrammatic representation of a network 2000. Network 2000 includes nodes for client computer systems 2002₁ through 2002_{N}, nodes for server computer systems 2004₁ through 2004_{N}, nodes for network infrastructure 2006₁ through 2006_{N}, any of which nodes may comprise a machine 2050 within which a set of instructions for causing the machine to perform any one of the techniques discussed above may be executed. The embodiment shown is purely exemplary, and a skilled person may implement the embodiment in the context of one or more of the figures herein without departing from the disclosure.

Any node of the network 2000 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A system also may implement a processor as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of any machine capable of executing a sequence of instructions that specify actions to be taken by that machine, including a virtual machine (VM), a virtual server, a virtual client, a virtual desktop, a virtual volume, a network router, a network switch, a network bridge, a personal digital assistant (PDA), a cellular telephone, and a web appliance. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 2050 includes a processor 2008 (e.g., a processor core, a microprocessor, a computing device, etc), a main memory 2010 and a static memory 2012, which communicate with each other via a bus 2014. The machine 2050 may further include a display unit 2016 that may comprise a touch-screen, or a liquid crystal display (LCD), or a light emitting diode (LED) display, or a cathode ray tube (CRT). As shown, the computer system 2050 also includes a human input/output (I/O) device 2018 (e.g., a keyboard, an alphanumeric keypad, etc), a pointing device 2020 (e.g., a mouse, a touch screen, etc), a drive unit 2022 (e.g., a disk drive unit, a CD/DVD drive, a tangible computer readable removable media drive, an SSD storage device, etc), a signal generation device 2028 (e.g., a speaker, an audio output, etc), and a network interface device 2030 (e.g., an Ethernet interface, a wired network interface, a wireless network interface, a propagated signal interface, etc).

The drive unit 2022 includes a machine-readable medium 2024 on which is stored a set of instructions (i.e., software, firmware, middleware, etc) 2026 embodying any one, or all, of the methodologies described above. The set of instructions 2026 also may reside, completely or at least partially, within the main memory 2010 and/or within the processor 2008. The network bus 2014 of the network interface device 2030 may provide a way to further transmit or receive the set of instructions 2026.

A computer may include a machine to perform calculations automatically. A computer may include a machine that manipulates data according to a set of instructions. In addition, a computer may include a programmable device that performs mathematical calculations and logical operations, especially one that can process, store and retrieve large amounts of data very quickly.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM), random access memory (RAM), magnetic disk storage media, optical storage media, flash memory devices, electrical, optical, acoustical, or any other type of media suitable for storing information.

A computer program product on a storage medium having instructions stored thereon/in may implement part or all of system 100. The system may use these instructions to control, or cause, a computer to perform any of the processes. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Storing may involve putting or retaining data in a memory unit such as a storage medium. Retrieving may involve locating and reading data from storage. Delivering may involve carrying and turning over to the intended recipient. For example, information may be stored by putting data representing the information in a memory unit, for example. The system may store information by retaining data representing the information in a memory unit, for example. The system may retrieve the information and deliver the information downstream for processing. The system may retrieve a message such as an advertisement from an advertising exchange system, carried over a network, and turned over to a member of a target-group of members.

Stored on any one of the computer readable medium, system 100 may include software both to control the hardware of a general purpose/specialized computer or microprocessor and to enable the computer or microprocessor to interact with a human consumer or other mechanism utilizing the results of system 100. Such software may include without limitation device drivers, operating systems, and user applications. Ultimately, such computer readable medium further may include software to perform system 100.

Although the system may utilize the techniques in the online advertising context, the techniques also may be applicable in any number of different open exchanges where the open exchange offers products, commodities, or services for purchase or sale. Further, many of the features described herein may help data buyers and others to target users in audience segments more effectively. However, while data in the form of segment identifiers may be generally stored and/or retrieved, examples of the invention preferably do not require any specific personal identifier information (e.g., name or social security number) to operate.

The techniques described herein may be implemented in digital electronic circuitry, or in computer hardware, firmware, software recorded on a computer-readable medium, or in combinations of them. The system may implement the techniques as a computer program product, i.e., a computer program tangibly embodied in an information carrier, including a machine-readable storage device, for execution by, or to control the operation of, data processing apparatus, e.g., a programmable processor, a computer, or multiple computers. Any form of programming language may convey a written computer program, including compiled or interpreted languages. A system may deploy the computer program in any form, including as a stand-alone program or as a module, component, subroutine, or other unit recorded on a computer-readable medium and otherwise suitable for use in a computing environment. A system may deploy a computer program for execution on one computer or on multiple computers at one site or distributed across multiple sites and interconnected by a communication network.

A system may perform the methods described herein in programmable processors executing a computer program to perform functions disclosed herein by operating on input data and generating output. A system also may perform the methods by special purpose logic circuitry and implement apparatus as special purpose logic circuitry special purpose logic circuitry, e.g., an FPGA (field programmable gate array) or an ASIC (application-specific integrated circuit). Modules may refer to portions of the computer program and/or the processor/special circuitry that implements that functionality. An engine may be a continuation-based construct that may provide timed preemption through a clock that may measure real time or time simulated through language like scheme. Engines may refer to portions of the computer program and/or the processor/special circuitry that implements the functionality. A system may record modules, engines, and other purported software elements on a computer-readable medium. For example, a processing engine, a storing engine, a retrieving engine, and a delivering engine each may implement the functionality of its name and may be recorded on a computer-readable medium.

Processors suitable for the execution of a computer program include, by way of example, both general and special purpose microprocessors, and any processors of any kind of digital computer. Generally, a processor may receive instructions and data from a read-only memory or a random access memory or both. Essential elements of a computer may be a processor for executing instructions and memory devices for storing instructions and data. Generally, a computer also includes, or may be operatively coupled to receive data from or transfer data to, or both, mass storage devices for storing data, e.g., magnetic, magneto-optical disks, or optical disks. Information carriers suitable for embodying computer program instructions and data include all forms of non-volatile memory, including by way of example semiconductor memory-devices, e.g., EPROM, EEPROM, and flash memory devices, magnetic disks, e.g., internal hard disks or removable disks, magneto-optical disks, and CD-ROM and DVD-ROM disks. A system may supplement a processor and the memory by special purpose logic circuitry and may incorporate the processor and the memory in special purpose logic circuitry.

To provide for interaction with a user, the techniques described herein may be implemented on a computer having a display device, e.g., a CRT (cathode ray tube) or LCD (liquid crystal display) monitor, for displaying information to the user and a keyboard and a pointing device, e.g., a mouse or a trackball, by which the user provides input to the computer (e.g., interact with a user interface element, for example, by clicking a button on such a pointing device). Other kinds of devices may be used to provide for interaction with a user as well, for example, feedback provided to the user includes any form of sensory feedback, e.g., visual feedback, auditory feedback, or tactile feedback, and input from the user may be received in any form, including acoustic, speech, or tactile input.

The techniques described herein may be implemented in a distributed computing system that includes a back-end component, e.g., as a data server, and/or a middleware component, e.g., an application server, and/or a front-end component, e.g., a client computer having a graphical user interface and/or a Web browser through which a user interacts with an implementation of the invention, or any combination of such back-end, middleware, or front-end components. A system may interconnect the components of the system by any form or medium of digital data communication, e.g., a communication network. Examples of communication networks include a local area network (“LAN”) and a wide area network (“WAN”), e.g., the Internet, and include both wired and wireless networks.

The computing system may include clients and servers. A client and server may be generally remote from each other and typically interact over a communication network. The relationship of client and server arises by virtue of computer programs running on the respective computers and having a client-server relationship to each other. One of ordinary skill recognizes any or all of the foregoing implemented and described as computer readable media.

In the above description, numerous details have been set forth for purpose of explanation. However, one of ordinary skill in the art will realize that a skilled person may practice the invention without the use of these specific details. In other instances, the disclosure may present well-known structures and devices in block diagram form to avoid obscuring the description with unnecessary detail. In other words, the details provide the information disclosed herein merely to illustrate principles. A skilled person should not construe this as limiting the scope of the subject matter of the terms of the claims. On the other hand, a skilled person should not read the claims so broadly as to include statutory and nonstatutory subject matter since such a construction is not reasonable. Here, it would be unreasonable for a skilled person to give a scope to the claim that is so broad that it makes the claim non-statutory. Accordingly, a skilled person is to regard the written specification and figures in an illustrative rather than a restrictive sense. Moreover, a skilled person may apply the principles disclosed to achieve the advantages described herein and to achieve other advantages or to satisfy other objectives, as well.

What is claimed is:

1. A method to price usage of a probability estimation system provided by an advertising exchange system for use in that advertising exchange system, the method comprising:
presenting, at a computer, a bid from each bidder in an auction for an advertising opportunity, where the bidders comprise a first group of bidders that utilize the probability estimation system and a second group of bidders that do not utilize the probability estimation system;
processing, in the computer, the bids by:
determining a first equilibrium bid for a first bidder as a member of the first group of bidders,
determining a second equilibrium bid for the first bidder as a member of the second group of bidders, and
utilizing the first equilibrium bid and the second equilibrium bid to determine a value of utilizing the Probability estimation system.

2. The method of claim 1, where the equilibrium bid for the first bidder as a member of the second group of bidders is a product of an expected value that utilizes probability estimation signals provided by bidders in the second group of bidders, a probability distribution function out of a first number of draws, and a probability distribution function out of a second number of draws.

3. The method of claim 2, where the equilibrium bid for the first bidder as a member of the second group of bidders is determined according to the equation
$${b}_{i}^{*} = arg {max}_{b} E [ ( p \cdot {v}_{i} - b ) \vert {s}_{i} ] {F}_{( 1 )}^{n} ( {β}_{1}^{- 1} ( b ) ) {F}_{( 1 )}^{k - 1} ( {β}_{2}^{- 1} ( b ) \vert {s}_{i} )$$
where,
*=denotes equilibrium,
i=a generic index identifying a bidder i,
bᵢ*=effective CPM equilibrium bid for each second group k-bidder i, i=1, . . . , n+k,
arg max=stands for an argument of a maximum, that is to say, a set of points of a given argument for which a value of a given expression attains its maximum value,
E[(p·vᵢ−b)|sᵢ]=a difference between an expected value of revenue a bidder can make from an impression auctioned (p·vᵢ) and a bid (b) given sᵢ,
sᵢ=a probability estimation signal provided by a bidder i in the second group of bidders,
β₁=an equilibrium strategy function in a symmetric equilibrium for n-bidders accessing a Probability estimation system,
β₂ an equilibrium strategy function in a symmetric equilibrium for k-bidders not accessing a Probability estimation system, a probability distribution function of a first order statistic out of n draws
F₍₁₎ⁿ(β₁⁻¹(b))=of an inverse of an equilibrium bid function for a given b value, and
F₍₁₎^{k-1}(β₂⁻¹(b)|sᵢ)=a probability distribution function of a first order statistic out of k−1 draws of an inverse of an equilibrium bid function for a given b value given sᵢ.

4. The method of claim 1, where the equilibrium bid for the first bidder as a member of the first group of bidders is a product of an expected value that utilizes a probability estimation signal provided by a Probability estimation system of the advertising exchange system, a probability distribution function out of a first number of draws, and a probability distribution function out of a second number of draws.

5. The method of claim 4, where the equilibrium bid for the first bidder is determined according to the equation
$${b}_{j}^{*} = arg {max}_{b} E [ ( p \cdot {v}_{i} - b ) \vert π ] {F}_{( 1 )}^{n - 1} ( {β}_{1}^{- 1} ( b ) ) {F}_{( 1 )}^{k} ( {β}_{2}^{- 1} ( b ) )$$
where,
*=denotes equilibrium,
bⱼ*=effective CPM equilibrium bid for each second group n-bidder j, j=1, . . . , n,
arg max=stands for an argument of a maximum, that is to say, a set of points of a given argument for which a value of a given expression attains its maximum value,
E[(p·vᵢ−b)|π]=is a difference between an expected value of a revenue a bidder can make from an impression auctioned (p·vᵢ) and a bid (b) given π,
π: π=p+ε, where π is an optimal estimation of p provided by a Probability estimation system of the advertising exchange system,
p=a true action probability of an advertising opportunity,
ε=is a noise term in a system's probability estimation,
β₁=an equilibrium strategy function in a symmetric equilibrium for n-bidders accessing a Probability estimation system,
β₂=an equilibrium strategy function in a symmetric equilibrium for k-bidders lacking access to a Probability estimation system,
F₍₁₎ⁿ⁻¹(β₁⁻¹(b))=a probability distribution function of a first order statistic out of n draws of an inverse of an equilibrium bid function for a given b value, and
F₍₁₎^{k}(β₂⁻¹(b))=a probability distribution function of a first order statistic out of k−1 draws of an inverse of an equilibrium bid function for a given b value.

6. The method of claim 1, further comprising:
estimating, in the computer, a probability variance on a conversion probability estimator;
determining, in the computer, the value of utilizing the probability estimation by subtracting the first equilibrium bid from the second equilibrium bid;
obtaining, in the computer, an empirical distribution of the number of bidders in the first group of bidders and the number of bidders in the second group of bidders; and
calculating, in the computer, an expected added value for a bidder in the second group of bidders for usage of the Probability estimation system.

7. The method of claim 6, further comprising:
utilizing a probability variance estimator to estimate the probability variance on the conversion probability estimator.

8. The method of claim 6, further comprising:
applying the value of utilizing the probability estimation as an upper bound on the price charged to a bidder in the second group of bidders.

9. The method of claim 6, where the expected added value for a bidder in the second group of bidders is a difference between an expected profit for a bidder utilizing a Probability estimation system provided by the advertising exchange system and an expected profit for a bidder not utilizing a Probability estimation system provided by the advertising exchange system.

10. The method of claim 9, where calculating the expected added value for a bidder in the second group of bidders includes utilizing the equation
Δ(n,k)=E_{v,p,π}[(pv−bⱼ^{n+1,k-1}(π))|π]−E_{v,p,s}[(pv−bⱼ^{n,k}(s))|sᵢ]
where,
n=a number of bidders who are part of the first group of bidders that utilize a Probability estimation system,
k=a number of bidders who are part of a second group of bidders that do not utilize a Probability estimation system,
Δ(n,k)=a value of a Probability estimation system service to the i^{th} bidder in the second group of bidders,
p=a true action probability of an advertising opportunity,
π=an optimal estimation of p provided by a Probability estimation system of the advertising exchange system,
bᵢ=effective CPM bid price for each bidder i, i=1, . . . , n+k,
v=an expected revenue for a given bidder from an auctioned impression provided that a consumer takes actions using an ad,
s=an estimate for a probability of action by a bidder in the second group of bidders,
E_{v,p,π}[(pv−bⱼ^{n+1,k-1}(π))|π]=an expected profit for a bidder in the second group of bidders when that bidder purchases information from the advertising exchange system and becomes a bidder in the first group of bidders, and
E_{v,p,s}[(pv−bⱼ^{n,k}(sᵢ))|sᵢ]=an expected profit for a bidder in the second group of bidders when that bidder does not purchase information from the advertising exchange system to remain as a bidder in the second group of bidders.

11. A computer readable medium containing executable instructions stored thereon, which, when executed in a computer, cause the computer to price usage of a Probability estimation system provided by an advertising exchange system for use in that advertising exchange system, the instructions for:
presenting, at a computer, a bid from each bidder in an auction for an advertising opportunity, where the bidders comprise a first group of bidders that utilize the Probability estimation system and a second group of bidders that do not utilize the Probability estimation system;
processing, in the computer, the bids by:
determining a first equilibrium bid for a first bidder as a member of the first group of bidders,
determining a second equilibrium bid for the first bidder as a member of the second group of bidders, and
utilizing the first equilibrium bid and the second equilibrium bid to determine a value of utilizing the Probability estimation system.

12. The computer readable medium of claim 11, where the equilibrium bid for the first bidder as a member of the second group of bidders is a product of an expected value that utilizes probability estimation signals provided by bidders in the second group of bidders, a probability distribution function out of a first number of draws, and a probability distribution function out of a second number of draws.

13. The computer readable medium of claim 12, where the equilibrium bid for the first bidder as a member of the second group of bidders is determined according to the equation
$${b}_{i}^{*} = arg {max}_{b} E [ ( p \cdot {v}_{i} - b ) \vert {s}_{i} ] {F}_{( 1 )}^{n} ( {β}_{1}^{- 1} ( b ) ) {F}_{( 1 )}^{k - 1} ( {β}_{2}^{- 1} ( b ) \vert {s}_{i} )$$
where,
*=denotes equilibrium,
i=a generic index identifying a bidder i,
bᵢ*=effective CPM equilibrium bid for each second group k-bidder i, i=1, . . . , n+k,
arg max=stands for an argument of a maximum, that is to say, a set of points of a given argument for which a value of a given expression attains its maximum value,
E[(p·vᵢ−b)|sᵢ]=a difference between an expected value of revenue a bidder can make from an impression auctioned (p·vᵢ) and a bid (b) given sᵢ,
sᵢ=a probability estimation signal provided by a bidder i in the second group of bidders,
β₁=an equilibrium strategy function in a symmetric equilibrium for n-bidders accessing a Probability estimation system,
β₂ an equilibrium strategy function in a symmetric equilibrium for k-bidders not accessing a Probability estimation system,
F₍₁₎ⁿ(β₁⁻¹(b))=a probability distribution function of a first order statistic out of n draws of an inverse of an equilibrium bid function for a given b value, and
F₍₁₎^{k-1}=(β₂⁻¹(b)|s₁)=a probability distribution function of a first order statistic out of k−1 draws of an inverse of an equilibrium bid function for a given b value given sᵢ.

14. The computer readable medium of claim 11, where the equilibrium bid for the first bidder as a member of the first group of bidders is a product of an expected value that utilizes a probability estimation signal provided by a Probability estimation system of the advertising exchange system, a probability distribution function out of a first number of draws, and a probability distribution function out of a second number of draws.

15. The computer readable medium of claim 14, where the equilibrium bid for the first bidder is determined according to the equation
$${b}_{j}^{*} = arg {max}_{b} E [ ( p \cdot {v}_{i} - b ) \vert π ] {F}_{( 1 )}^{n - 1} ( {β}_{1}^{- 1} ( b ) ) {F}_{( 1 )}^{k} ( {β}_{2}^{- 1} ( b ) )$$
where,
*=denotes equilibrium,
bⱼ*=effective CPM equilibrium bid for each second group n-bidder j, j=1, . . . , n,
arg max=stands for an argument of a maximum, that is to say, a set of points of a given argument for which a value of a given expression attains its maximum value,
E[(p·vᵢ−b)|π]=is a difference between an expected value of a revenue a bidder can make from an impression auctioned (p·vᵢ) and a bid (b) given π,
π: π=p+ε, where π is an optimal estimation of p provided by a Probability estimation system of the advertising exchange system,
p=a true action probability of an advertising opportunity,
ε=is a noise term in a system's probability estimation,
β₁=an equilibrium strategy function in a symmetric equilibrium for n-bidders accessing a Probability estimation system,
β₂=an equilibrium strategy function in a symmetric equilibrium for k-bidders lacking access to a Probability estimation system,
F₍₁₎ⁿ⁻¹(β₁⁻¹(b))=a probability distribution function of a first order statistic out of n draws of an inverse of an equilibrium bid function for a given b value, and
F₍₁₎^{k}β₁⁻¹(b))=a probability distribution function of a first order statistic out of k−1 draws of an inverse of an equilibrium bid function for a given b value.

16. The computer readable medium of claim 11, further comprising:
estimating, in the computer, a probability variance on a conversion probability estimator;
determining, in the computer, the value of utilizing the probability estimation by subtracting the first equilibrium bid from the second equilibrium bid;
obtaining, in the computer, an empirical distribution of the number of bidders in the first group of bidders and the number of bidders in the second group of bidders; and
calculating, in the computer, an expected added value for a bidder in the second group of bidders for usage of the Probability estimation system.

17. The computer readable medium of claim 16, further comprising:
utilizing a probability variance estimator to estimate the probability variance on the conversion probability estimator.

18. The computer readable medium of claim 16, further comprising:
applying the value of utilizing the probability estimation as an upper bound on the price charged to a bidder in the second group of bidders.

19. The computer readable medium of claim 16, where the expected added value for a bidder in the second group of bidders is a difference between an expected profit for a bidder utilizing a Probability estimation system provided by the advertising exchange system and an expected profit for a bidder not utilizing a Probability estimation system provided by the advertising exchange system.

20. The computer readable medium of claim 19, where calculating the expected added value for a bidder in the second group of bidders includes utilizing the equation
Δ(n,k)=E_{v,p,π[(}pv−bⱼ^{n+1,k-1}(π))|π]−E_{v,p,s}[(pv−bⱼ^{n,k}(s))|sᵢ]
where,
n=a number of bidders who are part of the first group of bidders that utilize a Probability estimation system,
k=a number of bidders who are part of a second group of bidders that do not utilize a Probability estimation system,
Δ(n,k)=a value of a Probability estimation system service to the i^{th} bidder in the second group of bidders,
p=a true action probability of an advertising opportunity,
π=an optimal estimation of p provided by a Probability estimation system of the advertising exchange system,
bᵢ=effective CPM bid price for each bidder i, i=1, . . . , n+k,
v=an expected revenue for a given bidder from an auctioned impression provided that a consumer takes actions using an ad,
s=an estimate for a probability of action by a bidder in the second group of bidders,
E_{v,p,π[(pv-b}ⱼ^{n+1,k-1}(π))|π]=an expected profit for a bidder in the second group of bidders when that bidder purchases information from the advertising exchange system and becomes a bidder in the first group of bidders, and
E_{v,p,s}[(pv−bⱼ^{n,k}(sᵢ))|sᵢ]=an expected profit for a bidder in the second group of bidders when that bidder does not purchase information from the advertising exchange system to remain as a bidder in the second group of bidders.

23. A system to price usage of a Probability estimation system provided by the system for use in that system, the system comprising:
at least one server, comprising at least one processor and memory, to present a bid from each bidder in an auction for an advertising opportunity, where the bidders comprise a first group of bidders that utilize the Probability estimation system and a second group of bidders that do not utilize the Probability estimation system; and
a processing platform, comprising at least one processor and memory, coupled to the server to process the bids by determining a first equilibrium bid for a first bidder as a member of the first group of bidders, determining a second equilibrium bid for the first bidder as a member of the second group of bidders, and utilizing the first equilibrium bid and the second equilibrium bid to determine a value of utilizing the Probability estimation system.

24. The system of claim 23, where the equilibrium bid for the first bidder as a member of the second group of bidders is a product of an expected value that utilizes probability estimation signals provided by bidders in the second group of bidders, a probability distribution function out of a first number of draws, and a probability distribution function out of a second number of draws.

25. The system of claim 24, where the equilibrium bid for the first bidder as a member of the second group of bidders is determined according to the equation
$${b}_{i}^{*} = arg {max}_{b} E [ ( p \cdot {v}_{i} - b ) \vert {s}_{i} ] {F}_{( 1 )}^{n} ( {β}_{1}^{- 1} ( b ) ) {F}_{( 1 )}^{k - 1} ( {β}_{2}^{- 1} ( b ) \vert {s}_{i} )$$
where,
*=denotes equilibrium,
i=a generic index identifying a bidder i,
bᵢ*=effective CPM equilibrium bid for each second group k-bidder i, i=1, . . . , n+k,
arg max=stands for an argument of a maximum, that is to say, a set of points of a given argument for which a value of a given expression attains its maximum value,
E[(p·vᵢ−b)|sᵢ]=a difference between an expected value of revenue a bidder can make from an impression auctioned (p·vᵢ) and a bid (b) given sᵢ,
sᵢ=a probability estimation signal provided by a bidder i in the second group of bidders,
β₁=an equilibrium strategy function in a symmetric equilibrium for n-bidders accessing a Probability estimation system,
β₂ an equilibrium strategy function in a symmetric equilibrium for k-bidders not accessing a Probability estimation system, a probability distribution function of a first order statistic out of n draws
F₍₁₎ⁿ(β₁⁻¹(b))=of an inverse of an equilibrium bid function for a given b value, and
F₍₁₎^{k-1}(β₂⁻¹(b)|s₁)=a probability distribution function of a first order statistic out of k−1 draws of an inverse of an equilibrium bid function for a given b value given sᵢ.

26. The system of claim 23, where the equilibrium bid for the first bidder as a member of the first group of bidders is a product of an expected value that utilizes a probability estimation signal provided by a Probability estimation system of the advertising exchange system, a probability distribution function out of a first number of draws, and a probability distribution function out of a second number of draws.

27. The system of claim 26, where the equilibrium bid for the first bidder is determined according to the equation
$${b}_{j}^{*} = arg {max}_{b} E [ ( p \cdot {v}_{i} - b ) \vert π ] {F}_{( 1 )}^{n - 1} ( {β}_{1}^{- 1} ( b ) ) {F}_{( 1 )}^{k} ( {β}_{2}^{- 1} ( b ) )$$
where,
*=denotes equilibrium,
bⱼ*=effective CPM equilibrium bid for each second group n-bidder j, j=1, . . . , n,
arg max=stands for an argument of a maximum, that is to say, a set of points of a given argument for which a value of a given expression attains its maximum value,
E[(p·vᵢ−b)|π]=is a difference between an expected value of a revenue a bidder can make from an impression auctioned (p·vᵢ) and a bid (b) given π,
π: π=p+ε, where π is an optimal estimation of p provided by a Probability estimation system of the advertising exchange system,
p=a true action probability of an advertising opportunity,
ε=is a noise term in a system's probability estimation,
β₁=an equilibrium strategy function in a symmetric equilibrium for n-bidders accessing a Probability estimation system,
β₂=an equilibrium strategy function in a symmetric equilibrium for k-bidders lacking access to a Probability estimation system,
F₍₁₎ⁿ⁻¹(β₁⁻¹(b))=a probability distribution function of a first order statistic out of n draws of an inverse of an equilibrium bid function for a given b value, and
F₍₁₎^{k}(β₂⁻¹(b))=a probability distribution function of a first order statistic out of k−1 draws of an inverse of an equilibrium bid function for a given b value.

28. The system of claim 23, the processing platform further for
estimating, in the computer, a probability variance on a conversion probability estimator;
determining, in the computer, the value of utilizing the probability estimation by subtracting the first equilibrium bid from the second equilibrium bid;
obtaining, in the computer, an empirical distribution of the number of bidders in the first group of bidders and the number of bidders in the second group of bidders; and
calculating, in the computer, an expected added value for a bidder in the second group of bidders for usage of the Probability estimation system.

29. The system of claim 28, the processing platform further for
utilizing a probability variance estimator to estimate the probability variance on the conversion probability estimator.

30. The system of claim 28, the processing platform further for
applying the value of utilizing the probability estimation as an upper bound on the price charged to a bidder in the second group of bidders.

31. The system of claim 28, where the expected added value for a bidder in the second group of bidders is a difference between an expected profit for a bidder utilizing a Probability estimation system provided by the advertising exchange system and an expected profit for a bidder not utilizing a Probability estimation system provided by the advertising exchange system.

32. The system of claim 31, where calculating the expected added value for a bidder in the second group of bidders includes utilizing the equation
Δ(n,k)=E_{v,p,π}[(pv−bⱼ^{n+1,k-1}(π))|π]−E_{v,p,s}[(pv−bⱼ^{n,k}(s))|sᵢ]
where,
n=a number of bidders who are part of the first group of bidders that utilize a Probability estimation system,
k=a number of bidders who are part of a second group of bidders that do not utilize a Probability estimation system,
Δ(n,k)=a value of a Probability estimation system service to the i^{th} bidder in the second group of bidders,
p=a true action probability of an advertising opportunity,
π=an optimal estimation of p provided by a Probability estimation system of the advertising exchange system,
bᵢ=effective CPM bid price for each bidder i, i=1, . . . , n+k,
v=an expected revenue for a given bidder from an auctioned impression provided that a consumer takes actions using an ad,
s=an estimate for a probability of action by a bidder in the second group of bidders,
E_{v,p,π[(pv-b}ⱼ^{n+1,k-1}(π))|π]=an expected profit for a bidder in the second group of bidders when that bidder purchases information from the advertising exchange system and becomes a bidder in the first group of bidders, and
E_{v,p,s}[(pv−bⱼ^{n,k}(sᵢ))|sᵢ]=an expected profit for a bidder in the second group of bidders when that bidder does not purchase information from the advertising exchange system to remain as a bidder in the second group of bidders.
